(19) United States
(12) Patent Application Publication
(10) Pub. No.: US 2026/0126874 A1
(43) Pub. Date: May 7, 2026

(54) TOUCH DISPLAY DEVICE AND DRIVING METHOD THEREOF

(71) Applicant: LG DISPLAY CO., LTD., Seoul (KR)

(72) Inventor: Hoon Bae KIM, Paju-si (KR)

(73) Assignee: LG DISPLAY CO., LTD., Seoul (KR)

(21) Appl. No.: 19/341,474

(22) Filed: Sep. 26, 2025

(30) Foreign Application Priority Data
Nov. 5, 2024 (KR) 10-2024-0155099

(51) Int. Cl. G06F 3/041; G06F 3/044; G09G 3/3233

(52) U.S. Cl. CPC G06F 3/041661; G06F 3/0446; G06F 2203/04108; G09G 3/3233; G09G 2320/068; G09G 2354/00; G09G 2380/10

(57) ABSTRACT

A touch display device includes pixels configured to display an input image; a pixel driving circuit configured to write pixel data of the input image to the pixels; touch and hover sensors configured to sense touch and hover inputs; and a sensor driving circuit configured to drive the touch and hover sensors. The sensor driving circuit binds sensing lines connected to the touch and hover sensors to sense the hover input and identify a user. A method for driving a touch display device is also disclosed.

### CROSS-REFERENCE TO RELATED APPLICATION

This application claims the benefit of and priority to Korean Patent Application No. 10-2024-0155099, filed Nov. 5, 2024, the entire contents of which are incorporated herein by reference for all purposes.

### BACKGROUND

### 1. Technical Field

The present disclosure relates to a device and particularly to, for example, without limitation, a display device and a driving method of the display device.

### 2. Description of Related Art

Various electronic devices employ touch display devices that can sense user inputs such as fingers or pens on their displays, which serve as user interfaces, thus enhancing user convenience. In recent years, touch recognition technology has been developed to enable hover sensing in a non-contact state as well as touch sensing on a screen of a touch display device.

A touch display device may be designed with partially different viewing angles, or it may employ technologies that allow the viewing angle to be controlled variably for each pixel area. For example, video content or visual information reproduced in the touch display device may be displayed only to a user within a range of narrow viewing angle or may be displayed to a plurality of users within a range of wide viewing angle.

As the market for future vehicles such as electric vehicles and autonomous vehicles expands, the demand for in-vehicle display devices is growing rapidly. A screen of an in-vehicle display device may be realized as a touch display device. In such an in-vehicle display device, a technology can be applied that makes the viewing angle of the screen partially different or varies the viewing angle of each pixel.

It is necessary to grant the screen control right of the touch display device to a specific user. However, touch recognition technology applicable to the touch display device cannot distinguish between users.

The description of related art should not be considered prior art merely because it is mentioned in or associated with this section. The description of related art includes information that describes one or more aspects of the subject technology, and the description in this section does not limit the scope of the invention.

### SUMMARY

An aspect of the present disclosure is to solve the above-described necessity and/or problems.

One or more aspects of the present disclosure provide a touch display device and a method of driving the same that may distinguish between users attempting to make touch/hover inputs.

The problem to be solved by the present disclosure is not limited to those mentioned above, and other problems not mentioned will be clearly understood by those skilled in the art from the following description.

A display panel according to one embodiment includes: pixels configured to display an input image; a pixel driving circuit configured to write pixel data of the input image to the pixels; touch and hover sensors configured to sense touch and hover inputs; and a sensor driving circuit configured to drive the touch and hover sensors. The sensor driving circuit binds sensing lines connected to the touch and hover sensors to sense the hover input and identify the user.

The touch and hover sensors may include: a plurality of first sensor electrodes connected to a plurality of first sensing lines parallel to each other; and a plurality of second sensor electrodes connected to a plurality of second sensing lines intersecting the first sensing lines and parallel to each other. The sensor driving circuit may include: a sensor driver configured to apply a driving signal to capacitance of the touch and hover sensors and to sense the amount of a charge or voltage change in the capacitance; and a sensor controller configured to control the sensor driver.

The sensor controller may provide the sensor driver with a reference driving signal directing the sensor driver to output the driving signal, a hover enable signal directing hover sensing, and a user identification enable signal directing user identification.

The sensor driver may output a pulse of the driving signal in response to the reference driving signal, and to vary at least one of a voltage and a frequency of the driving signal.

The sensor driver may include: a first driver configured to apply the driving signal to the sensing lines; a second driver including an amplifier to which a predetermined reference voltage or the driving signal is applied to a non-inverting terminal thereof; and a switching circuit configured to connect the first driver and an inverting terminal of the amplifier to a corresponding first sensing line or a corresponding second sensing line.

The pixels may be driven during a display interval. The touch and hover sensors may be driven during a touch sensing interval, a hover sensing interval, and a user identification interval. The sensing lines may be bound by a predetermined number during the hover sensing interval. A greater number of the sensing lines may be bound during the user identification interval than during the hover sensing interval.

A voltage charged in the capacitance of the touch and hover sensors is sensed by the hover sensing during the hover sensing interval and the user identification interval.

A resolution of the hover input sensed during the hover sensing interval is lower than a resolution of the touch input sensed during the touch sensing interval.

The resolution of the hover input sensed during the user identification interval may be lower than the resolution of the hover input sensed during the hover sensing interval.

A one frame period of the touch display device may include the display interval, the touch sensing interval, the hover sensing interval, and the user identification interval.

An (N)th frame period of the touch display device may include the display interval, the touch sensing interval, and the user identification interval, where N is a positive integer. An (N+1)th frame period may include the display interval, the hover sensing interval, and a user identification interval.

The touch and hover sensors may be driven at the same time as the pixels.

An (N)th (where N is a positive integer) frame period of the touch display device may include a touch sensing interval in which the pixels and the touch and hover sensors are driven simultaneously, and a user identification interval in which the pixels and the touch and hover sensors are driven simultaneously. An (N+1)th frame period may include a hover sensing interval in which the pixels and the touch and hover sensors are driven simultaneously, and a user identification interval in which the pixels and the touch and hover sensors are driven simultaneously.

Between the (N)th frame period and the (N+1)th frame period, a vertical blank period may be set in which the pixels and the touch and hover sensors are not driven.

The user identification interval may be set in a vertical blank period in which no pixels are driven during each of the (N)th frame period and the (N+1)th frame period.

A one frame period of the touch display device may include a touch sensing interval in which the pixels and the touch and hover sensors are simultaneously driven, a hover sensing interval in which the pixels and the touch and hover sensors are simultaneously driven, and a user identification interval in which the pixels and the touch and hover sensors are simultaneously driven.

The user identification interval may be set in a vertical blank period in which no pixels are driven.

A method of driving a touch display device according to one embodiment includes: driving pixels to display an input image; driving touch and hover sensors to sense a touch input in a contact state on a touch screen; driving the touch and hover sensors to sense a hover input in a non-contact state over the touch screen; and driving the touch and hover sensors to identify a user attempting to make touch and hover over the touch screen in a non-contact state.

According to embodiments of the present disclosure, applications that require user identification may be effectively operated by separately allocating intervals of frame periods to identify users attempting to make touch and hover inputs using a hover sensing method, and the control right of pixels and sensors may be set or changed for each user.

According to embodiments of the present disclosure, user identification may be performed in both the transverse and longitudinal directions to provide a wide range of user identification.

According to embodiments of the present disclosure, the number of the bounded sensing lines during the user identification interval may be increased to form a field high above the touch screen, facilitating the sensing of a user approaching the touch screen to attempt to make the touch and hover inputs.

According to embodiments of the present disclosure, the sensing sensitivity of the touch and hover inputs may be increased by separating the touch sensing interval and the hover sensing interval for each frame, thereby ensuring a longer sensing time for each interval.

According to embodiments of the present disclosure, since the display driving and the touch sensing are performed simultaneously, and the display driving and the hover sensing are performed simultaneously, it may be possible to sufficiently ensure the data voltage charging time of the pixels and the touch sensing and the hover sensing time. Therefore, the charging rate and the touch and hover sensing sensitivity of the pixels are improved.

According to embodiments of the present disclosure, a first driver and a second driver may be selectively connected to each of the intersecting sensing lines. As a result, the touch and hover sensors may be driven with mutual capacitance or self-capacitance.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram illustrating a touch display device according to one embodiment of the present disclosure;

FIG. 2 is a circuit diagram schematically illustrating a pixel circuit according to one embodiment of the present disclosure;

FIG. 3 is a diagram illustrating touch and hover sensors and a sensor driver in detail according to one embodiment of the present disclosure;

FIG. 4 is a diagram illustrating enable signals of touch and hover sensors according to one embodiment of the present disclosure;

FIGS. 5A and 5B are diagrams illustrating touch and hover sensing methods using a mutual capacitance sensing method according to one embodiment of the present disclosure;

FIGS. 6A and 6B are diagrams illustrating touch and hover sensing methods using self-capacitance connected to second sensor electrodes according to one embodiment of the present disclosure;

FIGS. 7A and 7B are diagrams illustrating touch and hover sensing methods using self-capacitance connected to first sensor electrodes according to one embodiment of the present disclosure;

FIG. 8 is a waveform diagram illustrating a touch display device and a driving method thereof according to one embodiment of the present disclosure;

FIG. 9 is a diagram illustrating one example of a method of sensing touch inputs during a touch sensing interval according to one embodiment of the present disclosure;

FIG. 10 is a diagram illustrating one example of a method for sensing hover input during a hover sensing interval according to one embodiment of the present disclosure;

FIG. 11 is a diagram illustrating an example of a user identification method during a user identification interval according to one embodiment of the present disclosure;

FIG. 12 is a diagram illustrating an example of selectively restricting touch and hover inputs using user identification in an in-vehicle display device according to one embodiment of the present disclosure;

FIG. 13 is a circuit diagram illustrating an example of a connection relationship between sensor electrodes and drivers in the mutual capacitance sensing method as shown in FIG. 9 according to one embodiment of the present disclosure;

FIG. 14 is a circuit diagram illustrating an example of a connection relationship between sensor electrodes and drivers in the mutual capacitance sensing method as shown in FIG. 10 according to one embodiment of the present disclosure;

FIGS. 15A and 15B are circuit diagrams illustrating an example of a connection relationship between sensor electrodes and drivers in the mutual capacitance sensing method as shown in FIG. 11 according to one embodiment of the present disclosure; and

FIGS. 16 to 20 are waveform diagrams illustrating a touch display device and a driving method thereof according to another embodiment of the present disclosure.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

Any implementation described herein as an “example” is not necessarily to be construed as preferred or advantageous over other implementations.

The terms such as “comprising,” “including,” “having,” and “containing” used herein are generally intended to allow other components to be added unless the terms are used with the term “only.” Any references to singular may include plural unless expressly stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

Also, when an element or layer is “connected,” “coupled,” or “adhered” to another element or layer denotes that the element or layer can not only be directly connected or adhered to another element or layer, but also be indirectly connected or adhered to another element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure. Furthermore, the present disclosure is only defined by scopes of claims.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

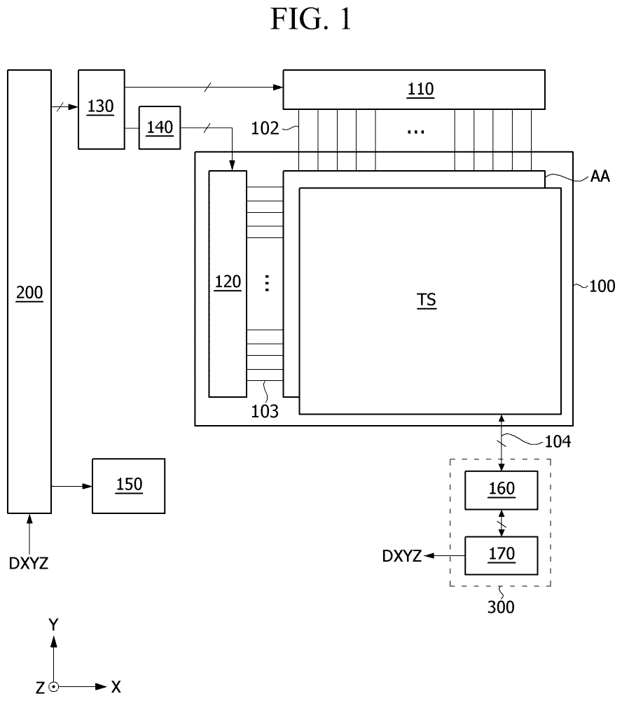

Referring to FIG. 1, a touch display device according to one embodiment of the present disclosure may include a display panel 100 on which pixels and touch and hover sensors TS are arranged, a pixel driving circuit 110 and 120 for writing image data to the pixels of the display panel 100, a sensor driving circuit 300 for driving the touch and hover sensors TS, and a power circuit 150 for generating power required to drive the pixel driving circuit 110 and 120 and the sensor driving circuit 300.

The display panel 100 may be a panel having a rectangular structure with a length in the X-axis direction, a width in the Y-axis direction, and a thickness in the Z-axis direction. The display panel 100 may be implemented as a non-transmissive display panel or a transmissive display panel. The transmissive display panel may be applied to a transparent display device in which an image is displayed on a screen and an actual object in the background is visible. The display panel 100 may be implemented as a flexible display panel.

In the display panel 100, a display area AA of a screen may include a pixel array for displaying images thereon. The pixel array includes a plurality of data lines 102, a plurality of gate lines 103 intersected with the plurality of data lines 102, a plurality of sensing lines 104, a plurality of pixels, and a plurality of touch and hover sensors TS. The display panel 100 may further include power lines commonly connected to the pixels. The power lines are connected to the pixels in common to supply constant voltages required for driving the pixels.

The pixels may be divided into two or more sub-pixels for color implementation. For example, three pixels, which are arranged sequentially along the X-axis direction, may be divided into a red sub-pixel, a green sub-pixel, and a blue sub-pixel. In another embodiment, four pixels, which are arranged sequentially along the X-axis direction, may be divided into a red sub-pixel, a green sub-pixel, a blue sub-pixel, and a white sub-pixel. Each of the sub-pixels may include a pixel circuit to drive a light-emitting element. The pixel circuit may be connected to the data line, the gate lines, and the power lines.

The timing controller 130 may receive pixel data of the input image and a timing signal synchronized with the pixel data from the host system 200. The timing signal may include a vertical synchronization signal Vsync, a horizontal synchronization signal Hsync, a main clock CLK, and a data enable signal DE. One cycle of the vertical synchronization signal Vsync may be a period of one frame. One cycle of the horizontal synchronization signal Hsync and the data enable signal DE may be one horizontal period. The pulse of the data enable signal DE may be synchronized with one line of data to be written to the pixels on one pixel line. Since a frame period and a horizontal period may be known by counting the data enable signal DE, the vertical synchronization signal Vsync and the horizontal synchronization signal Hsync may be omitted. The timing controller 130 may transmit the pixel data of the input image to the data driver 110 and control the operation timing of a data driver 110 and a gate driver 120. A gate timing control signal generated from the timing controller 130 may be input to the gate driver 120 through the level shifter 140. In addition, the timing controller 130 may synchronize the pixel driving circuit 110 and 120 and the sensor driving circuit 300.

The level shifter 140 may be connected between the timing controller 130 and the gate driver 120. The level shifter 140 may receive a gate timing control signal from the timing controller 130 and output a start pulse, a shift clock, etc. The level shifter 140 may change the swing width of the pulse by level shifting the voltage of an input signal. An input signal to the level shifter 140 may be a signal of a digital signal voltage level, and an output signal from the level shifter 140 may be an analog voltage signal that swings between a gate high voltage and a gate low voltage.

The data driver 110 may receive the pixel data of the input image received as a digital signal from the timing controller 130 and output the data voltage. The data driver 110 may convert the pixel data of the input image into a gamma-compensated voltage using a digital-to-analog converter, hereinafter referred to as “DAC,” and output the data voltage. A gamma reference voltage (VGMA) output from the power circuit 150 may be divided into the gamma-compensated voltage for each grayscale by a voltage divider circuit in the data driver 110 and supplied to the DAC. The DAC may generate the data voltage as the gamma compensated voltage corresponding to the grayscale value of the pixel data. The data voltage from the DAC may be output to the data lines 102 and a dummy data line (105 in FIG. 18) through an output buffer from the respective channels of the data driver 110.

The gate driver 120 may be arranged on the display panel 100. The gate driver 120 may be located in the non-display area outside the display area AA in the display panel 100, or at least a portion thereof may be located in the display area AA. The gate driver 120 may supply a gate signal to the gate lines 103 in a single feeding method. In the single feeding method, the gate signal may be applied to one ends of the gate lines 103. In a double feeding method, the gate signal may be applied simultaneously to opposite ends of the gate lines 103. The gate signal output from the gate driver 120 may be applied to the pixels of the display area AA. The gate driver 120 may shift the pulse of the gate signal using circuits such as a shift register, an edge trigger, and the like.

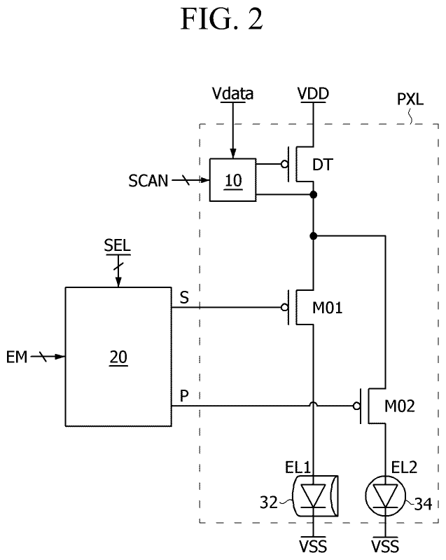

A plurality of gate signals may be applied to each of the pixels. For example, two or more scan signals (SCAN in FIG. 2) with different pulse widths and phases, and one or more light-emission signals (EM in FIG. 2) may be applied to each of the pixels. In this case, the gate driver 120 may include a plurality of gate drivers, each of which outputs the pulse of an individual gate signal.

The power circuit 150 may include, but is not limited to, a charge pump, a regulator, a buck converter, a boost converter, and the like. The power circuit 150 may receive a direct current input voltage from the host system 200 to generate the power required to drive the driving circuit 110 and 120 and the pixels of the display panel 100. The power circuit 150 may output a constant voltage (or DC voltage), such as the gamma reference voltage, the gate high voltage, the gate low voltage, etc. The power circuit 150 may also output a constant voltage provided to the pixels. The gamma reference voltage may be supplied to the data driver 110. The gate high voltage and the gate low voltage may be supplied to the level shifter 140 and the gate driver 120. The constant voltages input to the pixel circuit, such as pixel driving voltage, pixel ground voltage, etc. may be applied to the pixels via the power lines commonly connected to the pixels. The power circuit 150 may be implemented as a power management integrated circuit (PMIC), an electronics integrated circuit (ELI), or the like, but is not limited thereto.

The touch and hover sensors TS are connected to the sensor driving circuit 300 via the sensing line 104. The touch and hover sensors constituting the touch screen may be arranged in the form of an in-cell, an on-cell, and an add-on on the display area AA. Each of the touch and hover sensors TS may be implemented as a capacitance type touch and hover sensor. Here, the capacitance may be either self-capacitance or mutual capacitance. A touch input and a hover input may be sensed by any one of capacitance of the touch and hover sensors depending on how the sensor driving circuit 300 is driven, or a touch input and a hover input may be sensed as the capacitance type of the touch and hover sensors TS is varied. The touch input may be interpreted as a contact-type user input in which a conductive object such as a finger or a pen is in contact with the display panel 100. The hover input may be interpreted as a non-contact user input in which a conductive object approaches over the display panel 100 in a non-contact state.

The sensor driving circuit 300 may sense the touch input and the hover input based on the amount of a charge or voltage change before and after the touch/hover input in each of the touch and hover sensors TS by applying a driving signal to the touch and hover sensors TS. The sensor driving circuit 300 may include a sensor driver 160 and a sensor controller 170. The sensor driver 160 may be implemented as a read-out IC (ROIC) and the sensor controller 170 may be implemented as a microcontroller unit (MCU), but are not limited thereto.

The sensor driver 160 may supply a driving signal to the touch and hover sensors TS, convert the amount of a charge or voltage change before and after the touch/hover input into digital data, and output raw data. The sensor driver 160 may include a first driver that supplies the driving signal to the touch and hover sensors TS, and a second driver that includes an amplifier and an analog to digital converter (ADC). The sensor driver 160 may further include a switch circuit to selectively connect the sensing lines 104 to the first driver and the second driver. The switch circuit may be implemented as, but is not limited to, a multiplexer.

The sensor controller 170 analyzes the raw data input as the digital signal from the sensor driver 160 during a touch sensing interval and a hover sensing interval by performing a touch/hover sensing algorithm and calculates the coordinates of the touch/hover input position. Further, the sensor controller 170 may analyze the raw data in a user identification interval and output a user identification code (User ID) that identifies a user attempting to make the touch/hover inputs. The sensor controller 170 may identify the touch input, the hover input, and the user by comparing the raw data to a preset threshold. The threshold may be distinguished as one or more, but is not limited thereto.

A sensor signal DXYZ output from the sensor controller 170, which includes the touch input, the hover input, and user identification information, is transmitted to the host system 200. The host system 200 may perform an application program associated with the coordinate value of the touch input and the hover input in response to the sensor signal DXYZ received as digital signals, and may set and change the control right or the application program associated with the user identification information.

The display panel 100 may be divided into a plurality of pixel regions with different viewing angles. For example, the display panel 100 may include a first pixel region that emits light in a narrow viewing angle, allowing images of the first content to be visible only to users at a particular location, and a second pixel region that emits light at a wide viewing angle, allowing images of the second content to be visible to users at different locations. A first lens for condensing light from a light-emitting element at narrow viewing angle may be arranged in each of the pixels in the first pixel region. A second lens for diffusing light from a light-emitting element at a wide viewing angle may be arranged in each of the pixels of the second pixel region.

In other embodiments, each of the pixels of the display panel 100 may be electrically controlled to have a variable viewing angle. For example, as shown in FIG. 2, each of the sub-pixels may include a pixel circuit for driving a light-emitting element EL1 for a wide viewing angle and a light-emitting element EL2 for a narrow viewing angle. The pixel driving circuit 110 and 120 may selectively drive the light-emitting elements EL1 and EL2 in the sub-pixels under the control of the timing controller 130 to vary the viewing angle of each of the sub-pixels.

FIG. 2 is a circuit diagram schematically illustrating a pixel circuit according to one embodiment of the present disclosure.

Referring to FIG. 2, a pixel circuit PXL drives a first light-emitting element EL1 in a first viewing angle mode and a second light-emitting element EL2 in a second viewing angle mode. The pixel circuit includes the first light-emitting element EL1, the second light-emitting element EL2, a driving element DT to drive the first and second light-emitting elements EL1 and EL2, a compensation circuit 10 connected to the driving element DT, a first switch element M01 connected between the driving element DT and the first light-emitting element EL1, and a second switch element M02 connected between the driving element DT and the second light-emitting element EL2. The driving element DT and the switch elements M01 and M02 may be implemented as, but not limited to, transistors.

The light-emitting elements EL1 and EL2 may be implemented as, but is not limited to, an organic light-emitting element, such as an organic light-emitting diode (OLED), or an inorganic light-emitting element (LED), such as a micro light-emitting diode.

The first light-emitting element EL1 may be driven by a current provided from the driving element DT through the first switch element M01 to emit light in the first viewing angle mode. The first light-emitting element EL1 includes an anode electrode connected to a drain electrode of the first switch element M01, and a cathode electrode connected to a VSS node to which a pixel ground voltage VSS is applied. The second light-emitting element EL2 may be driven by a current provided from the driving element DT through the second switch element M02 to emit light in the second viewing angle mode. The second light-emitting element EL2 includes an anode electrode connected to a drain electrode of the second switch element M02, and a cathode electrode connected to a VSS node to which the pixel ground voltage VSS is applied.

A first lens 32 may be a wide viewing angle lens arranged over the first light-emitting element EL1. The first lens 32 overlap the light emission area of the first light-emitting element EL1. The first lens 32 may be implemented as a semi-cylindrical lens to limit the up-down viewing angle while increasing the left-right viewing angle. The first lens 32 is long in the left-right direction (or X-axis direction) of the display panel 100 and is narrow in the up-down direction (Y-axis direction). The first lens 32 may condense the light from the first light-emitting element EL1 in the up-down direction and diffuse the light to the wide viewing angle in the left-right direction, thereby allowing the light from the first light-emitting element EL1 to proceed to the wide viewing angle in the left-right direction. The second lens 34 may be a narrow viewing angle lens arranged over the second light-emitting element EL2. The second lens 34 overlap the light emission area of the second light-emitting element EL2. The second lens 34 may be a hemispherical lens which is thicker in the center and becomes thinner toward the edge in the up-down and left-right directions. The second lens 34 may condense the light from the second light-emitting element EL2, allowing the light emitted from the second light-emitting element EL2 to proceed to the narrow viewing angle in the up-down and left-right directions.

In a vehicle, the first and second lenses 32 and 34 may prevent or reduce the pixels from being visible due to light from the pixels being reflected off the windshield of the vehicle by limiting the up-down viewing angle of the pixels. The first and second lenses 32 and 34 may be implemented as, but are not limited to, a transparent medium or a transparent insulating layer pattern disposed within the display panel 100.

The driving element DT generates a current according to the gate-source voltage to drive the first and second light-emitting elements EL1 and EL2. The drive element DT may include a source electrode to which a pixel driving voltage VDD is applied, a gate electrode to which a data voltage Vdata of pixel data is applied, and a drain electrode connected to the source electrodes of the first and second switch elements M01 and M02. The compensation circuit 10 may be connected to, but is not limited to, the driving element DT. The compensation circuit 10 may initialize the pixel circuit using two or more switch elements, which are turned on/off according to the voltage of the scan signal SCAN, and a capacitor, sample a threshold voltage of the driving element DT, and apply the data voltage Vdata compensated by the amount of the threshold voltage to the gate electrode of the driving element DT.

The first switch element M01 is connected between the driving element DT and the first light-emitting element EL1 and is turned on in response to a gate-on voltage of a first viewing angle mode signal S. When the first switch element M01 is turned on, the driving element DT is electrically connected to the first light-emitting element EL1 so that the first light-emitting element EL1 may be emitted. The first switch element M01 includes a source electrode connected to the drain electrode of the driving element DT, a gate electrode to which the first viewing angle mode signal S is applied, and a drain electrode connected to the anode electrode of the first light-emitting element EL1. The second switch element M02 is connected between the driving element DT and the anode electrode of the second light-emitting element EL2, and is turned on in response to a gate-on voltage of a second viewing angle mode signal P. When the second switch element M02 is turned on, the driving element DT is electrically connected to the second light-emitting element EL2 so that the second light-emitting element EL2 may be emitted. The second switch element M02 includes a source electrode connected to the drain electrode of the drive element DT, a gate electrode to which the second viewing angle mode signal P is applied, and a drain electrode connected to the anode electrode of the second light emitting element EL2. If the first and second switch elements M01 and M02 as p-channel transistors are driven, the gate-on voltage may be a gate low voltage and the gate-off voltage may be a gate high voltage.

The first and second viewing angle mode signals S and P may be output from a mode selection circuit 20. The mode selection circuit 20 may be embedded in or electrically connected to the pixel circuit PXL in each of the sub-pixels. The mode selection circuit 20 may control the viewing angle of each of the sub-pixels by outputting the first and second viewing angle mode signals S and P under the control of the timing controller 130.

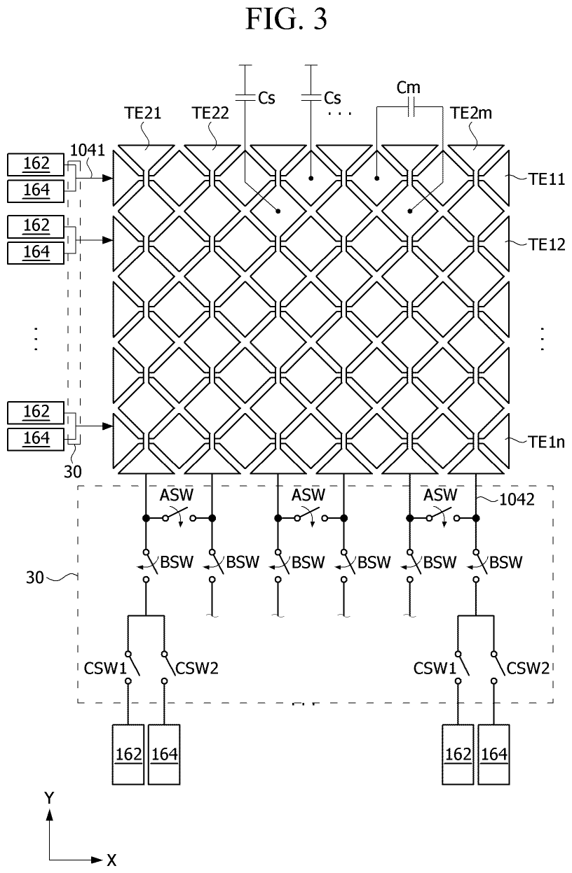

FIG. 3 is a diagram illustrating the touch and hover sensors and the sensor driver in detail according to one embodiment of the present disclosure.

Referring to FIG. 3, the touch and hover sensors TS include first sensor electrodes TE11 to TE1n connected to first sensing lines 1041, and second sensor electrodes TE21 to TE2m connected to second sensing lines 1042 that intersect with the first sensing lines 1041. The first sensing lines 1041 may be metallic wires in the X-axis direction. The second sensing lines 1042 may be metallic wires in the Y-axis direction.

The first sensor electrodes TE11 to TE1n and the second sensor electrodes TE21 to TE2m are arranged to be insulated from each other in the same plane of an insulating layer. The first sensor electrodes TE11 to TE1n and the second sensor electrodes TE21 to TE2m may be patterned in a mesh to increase the transmittance of the pixels, but are not limited thereto. The sensor electrodes TE1 and TE2 may have widths that decrease at the intersection between the sensor electrodes TE1 and TE2. At the intersection of the first sensor electrodes TE11 to TE1n and the second sensor electrodes TE21 to TE2m, the first sensor electrodes TE11 to TE1n or the second sensor electrodes TE21 to TE2m may be connected through a bridge penetrating the insulating layer.

Each of the first sensing lines 1041 and the second sensing lines 1042 may be connected to a first driver 162 and a second driver 164 through switch elements in a switch circuit 30. In FIG. 3, a switch circuit connected to the first sensing lines 1041 is omitted.

Self-capacitance Cs is formed between the first sensor electrodes TE11 to TE1narranged along the first sensing lines 1041 and the conductive object. When the second driver 164 is connected to the first sensing lines 1041 through the switch circuit, the self-capacitance Cs of the first sensor electrodes TE11 to TE1n may be charged through the second driver 164, so that the amount of a charge or voltage change charged in the self-capacitance may be sensed on the first sensor electrodes TE11 to TE1n. Further, the self-capacitance Cs is formed between the second sensor electrodes TE21 to TE2m arranged along the second sensing lines 1042 and the conductive object. When the second driver 164 is connected to the second sensing lines 1042, the self-capacitance Cs of the second sensor electrodes TE21 to TE2m may be charged through the second driver 164, so that the amount of a charge or voltage change charged in the self-capacitance Cs may be sensed on the second sensor electrodes TE21 to TE2m.

Mutual capacitance Cm is formed between the first sensor electrodes TE11 to TE1n and the second sensor electrodes TE21 to TE2m, which are adjacent to each other, at the intersection. When the first driver 162 is connected to the first sensing line 1041 through the switch circuit and the second driver 164 is connected to the second sensing line 1042 through the switch circuit, the amount of a charge or voltage change charged in the mutual capacitance Cm may be sensed. Further, when the first driver 162 is connected to the second sensing line 1042 through the switch circuit and the second driver 164 is connected to the first sensing line 1041 through the switch circuit, the amount of a charge or voltage change charged in the mutual capacitance Cm may be sensed.

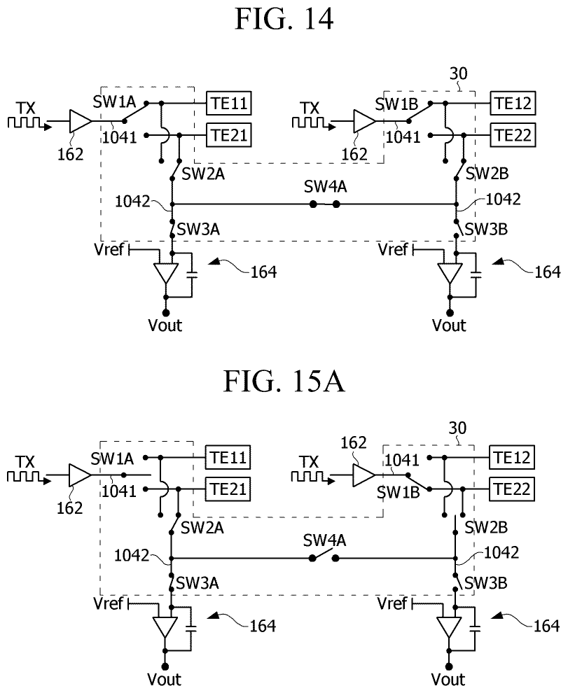

The switch circuit selectively connects the sensing lines 1041 and 1042 to the first driver 162 and the second driver 164 under the control of the sensor controller 170. The switch circuit may include, but is not limited to, a plurality of switch elements ASW selectively connecting the sensing lines 1041 and 1042 adjacent to each other in parallel, and a plurality of switch elements BSW, CSW1, and CSW2 selectively connecting the first driver 162 and the second driver 164 corresponding to the respective sensing lines 1041 and 1042. The operation of the switch circuit will be described in detail with reference to FIGS. 13 to 15B.

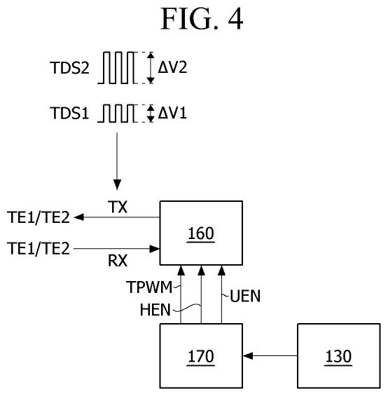

FIG. 4 is a diagram illustrating enable signals of the touch and hover sensors according to one embodiment of the present disclosure.

Referring to FIG. 4, the sensor controller 170 may control the sensor driver 160 by providing the sensor driver 160 with a reference driving signal TPWM that indicates the output of the driving signal, a hover enable signal HEN that directs hover sensing, and a user identification enable signal UEN that indicates user identification. The timing controller 130 may provide a synchronization signal, such as, but not limited to, a vertical synchronization signal (Vsync) to the sensor controller 170.

The sensor driver 160 may output the pulse of a driving signal TX in response to the pulse of the reference driving signal TPWM. The pulse of the driving signal TX is generated as a square wave, sine wave, or triangle wave and is applied to the sensor electrodes TE1 and TE2. The capacitance of the touch and hover sensors charges according to the pulse voltage of the driving signal TX. The voltage of the driving signal TX output from the sensor driver 160 may be variable, such as ΔV1, ΔV2, and the like, but is not limited thereto. In FIG. 4, TDS1 is a driving signal with a relatively low voltage ΔV1, and TDS2 is a driving signal with a high voltage ΔV2. The frequency of the driving signal TX may also be varied depending on the sensing interval, but is not limited thereto. The reference driving signal TPWM may be generated as a pulse width modulation signal and may include pulse timing, frequency, and voltage information of the driving signal TX.

The sensor controller 170 may identify the hover input and the user by executing a hover sensing algorithm during the hover sensing interval and the user identification interval. The sensor controller 170 may output the hover enable signal HEN at an active level during the hover sensing interval and the user identification interval, and output the hover enable signal HEN at an inactive level during other periods. The sensor controller 170 may output the user identification enable signal UEN at an active level during the user identification interval and output the user identification enable signal UEN at an in active level during other periods. The active level may be, but is not limited to, high level (H) or “1” and the inactive level may be low level (L) or “0”.

During the touch sensing interval, the sensor driver 160 senses the touch input with high resolution. For example, the sensor driver 160 may sense the charge or voltage of the capacitance Cm or Cs by individually applying a driving signal TX to the sensing lines 1041 and 1042 while the sensing lines 1041 and 1042 are separated during the touch sensing interval. During the touch sensing interval, both the hover enable signal HEN and the user identification enable signal UEN may be at the inactive level. In this case, the sensor driver 160 may operate by a touch sensing method when both the hover enable signal HEN and the user identification enable signal UEN are at the inactive level.

During the hover sensing interval, the sensor driver 160 senses the hover input at relatively high resolution by sensing a conductive object that is approaching over the touch screen in a non-contact state. In this case, in order to locate the field higher on the sensor electrodes TE1 and TE2, the switch circuit 30 is used to bind the adjacent sensing lines 1041 and 1042 by i (i is an integer that is 2 or greater) to sense the charge or voltage of the capacitances Cm and Cs. During the hover sensing interval, since the sensing lines are bound, the hover input resolution may be lower than the touch input resolution. During the hover sensing interval, the hover enable signal HEN may be generated at the active level and the user identification enable signal UEN may be at the disable level. In this case, the sensor driver 160 may operate by a hover sensing method when the hover enable signal HEN is generated at the active level and the user identification enable signal UEN is at the disable level.

During the user identification interval, the sensor driver 160 senses a conductive object, such as a user's finger, that is approaching over the touch screen in a non-contact state to identify a user attempting to make a touch or hover input. In this case, in order to locate the field higher on the sensor electrodes TE1 and TE2, the adjacent sensing lines 1041 and 1042 may be bound by j (j is an integer greater than i) by the switch circuit, and the driving signal TX may then be applied to the bound sensing lines 1041 and 1042 to sense the charge or voltage of the capacitances Cm and Cs. Because more sense lines are bound during the user identification interval than during the hover sensing interval, the hover input resolution of the user identification interval may be lower than the touch input resolution of the hover sensing interval.

During the user identification interval, since it is sufficient to identify users attempting to make a touch input or a hover input, more sensing lines 1041 and 1042 are bound than during the hover sensing interval, resulting in the field being located higher. During the user identification interval, both the hover enable signal HEN and the user identification enable signal UEN may be at the active level. In this case, the sensor driver 160 identifies a user attempting to make a touch or hover input by the hover sensing method when both the hover enable signal HEN and the user identification enable signal UEN are at the active level.

During the touch sensing interval, the sensor controller 170 analyzes the raw data received from the sensor driver 160 using a touch sensing algorithm and transmits the sensor signal DXYZ including information about the touch input position (coordinate value) to the host system 200. During the hover sensing interval, the sensor controller 170 analyzes the raw data received from the sensor driver 160 using a hover sensing algorithm and transmits the sensor signal DXYZ including information about the hover input position (coordinate value) to the host system 200.

During the user identification interval, the sensor controller 170 analyzes the raw data input from the sensor driver 160 using a hover sensing algorithm and transmits the sensor signal DXYZ including a user identification code, which indicates a user attempting to make a touch or hover input, to the host system 200. During the user identification interval, the sensor signal DXYZ output from the sensor controller 170 may include only the user identification code without the location information of the touch and hover inputs.

The sensor driver 160 may increase the voltage of the driving signal TX and/or increase the frequency of the driving signal TX in order to locate the field higher on the touch screen during at least one of the hover sensing interval and the user identification interval, but is not limited thereto.

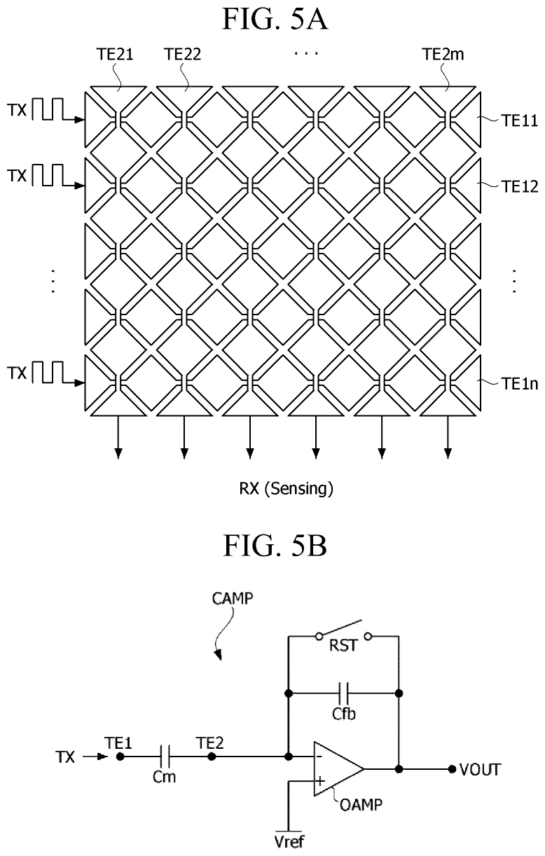

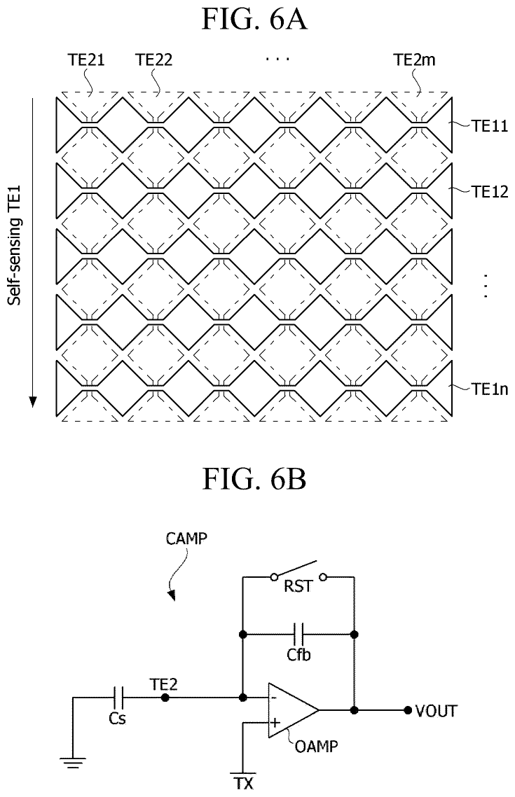

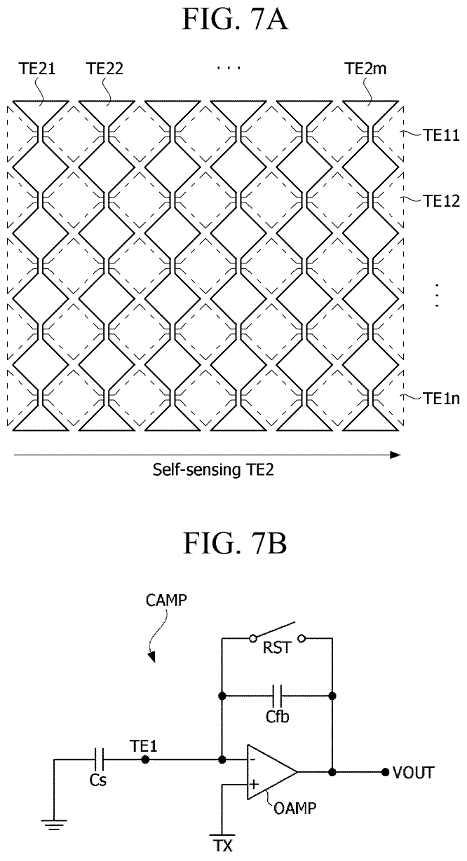

FIGS. 5A and 5B are diagrams illustrating touch and hover sensing methods using a mutual capacitance. FIGS. 6A and 6B are diagrams illustrating touch and hover sensing methods using self-capacitance connected to second sensor electrodes. FIGS. 7A and 7B are diagrams illustrating touch and hover sensing methods using self-capacitance connected to first sensor electrodes. In FIGS. 5B, 6B, and 7B, “CAMP” denotes the amplifier of the second driver. The amplifier includes an op-amp OAMP, a feedback capacitor Cfb connected in parallel between an inverting input terminal (−) and an output terminal of the op-amp OAMP, and a reset switch RST. A reference voltage Vref or a pulse of the driving signal TX may be applied to a non-inverting input terminal (+) of the op-amp OAMP.

Referring to FIG. 5A and FIG. 5B, the mutual capacitance Cm is formed between the first sensor electrodes TE11 to TE1n and the second sensor electrodes TE21 to TE2m when the first driver is connected to the first sensor electrodes TE11 to TE1n to apply the pulse of the driving signal TX to the first sensor electrodes TE11 to TE1n and when the second driver is connected to the second sensor electrodes TE21 to TE2m. In this configuration, the mutual capacitance is connected to the inverting input terminal (−) of the op-amp OAMP, and the reference voltage Vref is applied to the non-inverting input terminal (+) of the op-amp OAMP.

Whenever the pulse of the driving signal TX is applied to the mutual capacitance Cm, the mutual capacitance Cm is charged, and the charge of the mutual capacitance Cm is accumulated in the feedback capacitor Cfb of the amplifier CAMP, and an output voltage VOUT is generated from the amplifier CAMP. The amount of charge in the mutual capacitance Cm varies depending on the capacitance of the conductive object connected to the mutual capacitance Cm, and as a result, the amount of charge in the mutual capacitance Cm varies between a touch and hover inputs. Therefore, the output voltage VOUT of the amplifier CAMP varies before and after the touch and hover inputs. The output voltage VOUT of the amplifier CAMP is converted to digital data by an analog-digital converter ADC and output as raw data.

Referring to FIGS. 6A and 6B, when the pulse of the driving signal TX is applied to the amplifier CAMP connected to the second sensing lines 1042 as it is shifted from the left side to the right side of the touch screen, the self-capacitance may be scanned as the touch screen is sequentially scanned from the top to the bottom of the touch screen. In this case, while the first sensor electrodes TE21 to TE2m are floating without being connected to the first driver and the second driver, the pulse of the driving signal TX may be applied to the non-inverting input terminal (+) of the op-amp OAMP connected to the second sensor electrodes TE21 to TE2m. The self-capacitance Cs connected to the second sensor electrodes TE21 to TE2m may be charged by the pulse of the driving signal TX applied to the non-inverting input terminal (+) of the amplifier OAMP. The charge of the self-capacitance Cs is accumulated in the feedback capacitor Cfb of the amplifier CAMP, resulting in the output voltage VOUT of the amplifier CAMP. The output voltage VOUT of the amplifier CAMP varies before and after the touch and hover inputs, and is converted into digital data by the ADC and output as raw data.

Referring to FIGS. 7A and 7B, when the pulse of the driving signal TX is applied to the amplifier CAMP connected to the first sensing lines 1041 as it is shifted from the top to the bottom of the touch screen, the self-capacitance may be scanned as the touch screen is sequentially scanned from the top to the bottom of the touch screen. In this case, while the second sensor electrodes TE21 to TE2m are floating without being connected to the first driver and the second driver, the pulse of the driving signal TX may be applied to the non-inverting input terminal (+) of the op-amp OAMP connected to the first sensor electrodes TE11 to TE1n. The self-capacitance Cs connected to the first sensor electrodes TE11 to TE1n may be charged as the pulse of the driving signal TX is applied to the non-inverting input terminal (+) of the amplifier OAMP. The charge of the self-capacitance Cs is accumulated in the feedback capacitor Cfb of the amplifier CAMP, resulting in the output voltage VOUT of the amplifier CAMP. The amount of charge in the self-capacitance Cs varies depending on the capacitance of the conductive object connected to the self-capacitance Cs, and as a result, the amount of charge in the self-capacitance Cs varies due to touch and hover input charges. Therefore, the output voltage VOUT of the amplifier CAMP varies before and after the touch and hover inputs. The output voltage VOUT of the amplifier CAMP is converted to digital data by an analog-digital converter ADC and output as raw data.

The touch sensing method and the hover sensing method may suitably utilize the mutual capacitance sensing method illustrated in FIGS. 5A and 5B, and the self-capacitance sensing method illustrated in FIGS. 6A to 7B.

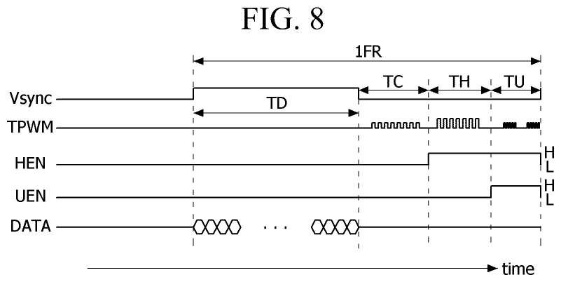

FIG. 8 is a waveform diagram illustrating a touch display device and a driving method thereof according to one embodiment of the present disclosure. In FIG. 8, “Vsync” is a vertical synchronization signal.

Referring to FIG. 8, a one frame period (1FR) may be time-divided into a display interval TD, a touch sensing interval TC, a hover sensing interval TH, and a user identification interval TU.

During the display interval TD, pixel data of the input image is written to the pixels to drive the pixels. At this point, the image is displayed in the pixels. The touch and hover sensors TS are not driven during the display interval TD.

The touch and hover sensors TS are driven during the touch sensing interval TC, the hover sensing interval TH, and the user identification interval TU. During the touch sensing interval TC, the hover sensing interval TH, and the user identification interval TU, no new pixel data is written to the pixels, but the pixels may maintain the luminance of the light-emitting elements with the data voltage previously charged to a storage capacitor. During the touch sensing interval TC, the hover sensing interval TH, and the user identification interval TU, the touch and hover sensors TS may be driven by the mutual capacitance sensing method or the self-capacitance sensing method.

The pulse of the reference driving signal TPWM may be input to the sensor driver 160 during the touch sensing interval TC, the hover sensing interval TH, and the user identification interval TU to cause the pulse of the driving signal TX to be applied to the touch and hover sensors TS. One or more of the pulse voltage and frequency of the driving signal TX may be set differently for each interval. As an example, the voltage of the driving signal TX generated during the hover sensing interval TH may be higher than the voltage of the driving signal TX generated during the touch sensing interval TC and the user identification interval TU, but is not limited thereto. The frequency of the driving signal TX generated during the user identification interval TU may be higher than the frequency of the driving signal TX generated during the touch sensing interval TC and the hover sensing interval TH, but is not limited thereto.

The hover enable signal HEN may be at an inactive level (L) during the display interval TD and the touch sensing interval TC, and at the active level (H) during the hover sensing interval TH and the user identification interval TU. The user identification enable signal UEN may be at an inactive level (L) during the display interval TD, the touch sensing interval TC, and the hover sensing interval TH, and may be at an active level (H) during the user identification interval TU.

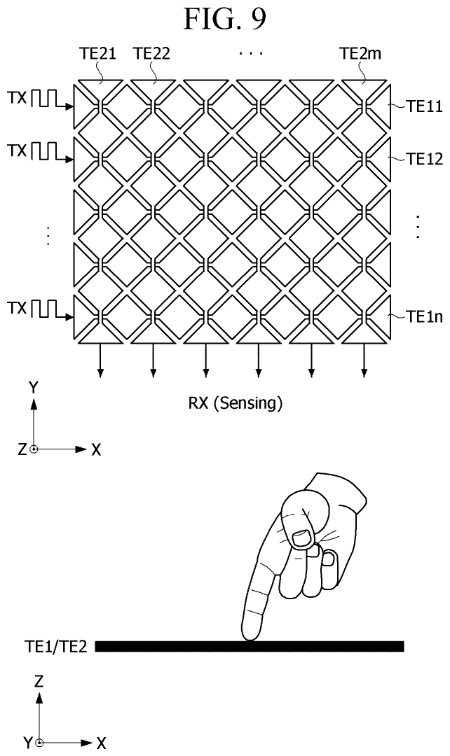

During the touch sensing interval TC, a touch input made on the touch screen may be sensed, as shown in FIG. 9. The example of FIG. 9 includes, but is not limited to, sensing a touch input by applying the pulse of the driving signal TX to the first sensor electrodes TE11 to TE1n and sensing the amount of a charge or voltage change in the mutual capacitance through the second sensor electrodes TE21 to TE2m. During the touch sensing interval TC, a touch input may be sensed by sensing a self-capacitance coupled to the first sensor electrodes TE11 to TE1n or a self-capacitance coupled to the second sensor electrodes TE21 to TE2m by the sensing method described above, as shown in FIGS. 6A to 7B. In FIG. 9, the reference numerals “TE1/TE2” denote the sensor electrodes that sense the touch input.

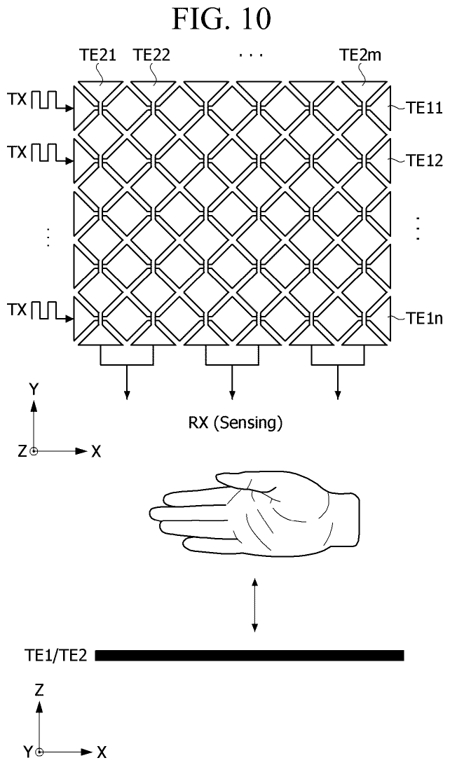

During the hover sensing interval TH, as shown in FIG. 10, a hover input in a non-contact state may be sensed over the touch screen. The example of FIG. 10 includes, but is not limited to, sensing a hover input by binding the first sensor electrodes TE11 to TE1n so that the pulse of the driving signal TX is applied simultaneously to them, and by binding the second sensor electrodes TE21 to TE2m so that a change in charge or voltage of the mutual capacitance is sensed by the bounded second sensor electrodes TE21 to TE2m. During the hover sensing interval TH, the touch input may be sensed by sensing a self-capacitance coupled to the first sensor electrodes TE11 to TE1n or a self-capacitance coupled to the second sensor electrodes TE21 to TE2m by the sensing method described above, as shown in FIGS. 6A to 7B. In FIG. 10, the reference numerals “TE1/TE2” denote the sensor electrodes that sense the touch input.

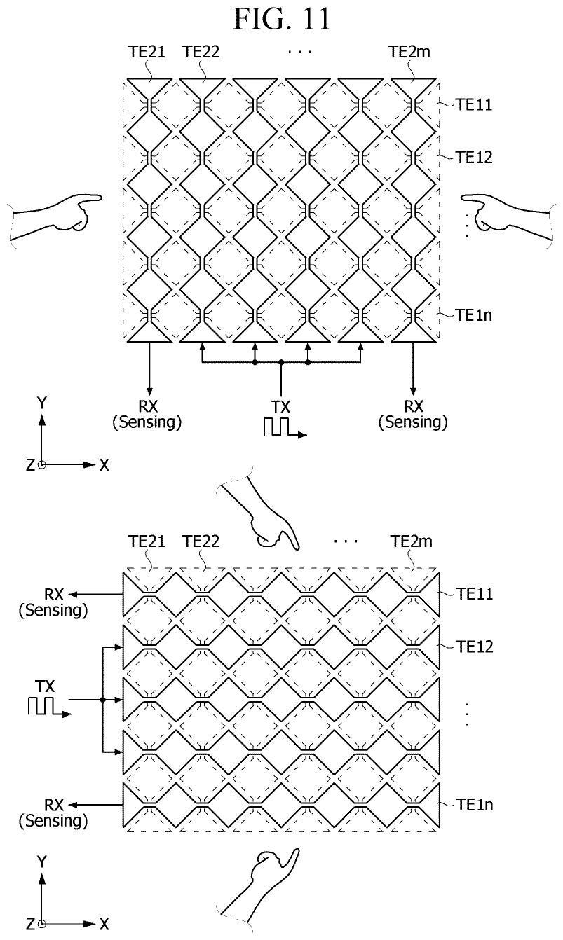

During the user identification interval TU, a user approaching over the touch screen in a non-contact state may be sensed by the hover sensing method, as shown in FIG. 11. As in the example of FIG. 11, the second sensing lines except for the second sensing lines at both the left and right ends are bound so that the pulse of the driving signal TX is applied to them simultaneously, and the amount of a charge or voltage change in the mutual capacitance coupled to the first sensor electrodes TE11 to TE1n is sensed through the first sensing lines at both the left and right ends is sensed, thereby identifying a user attempting to make a touch or hover input on the touch screen may be identified in the left and right directions. In this case, the field that affect the mutual capacitance may be formed to be high between the left and right sides of the touch screen.

Then, the first sensing lines except for the first sensing lines at both the upper and lower ends are bound so that the pulse of the driving signal TX is applied to them simultaneously, and the amount of a charge or voltage change in the mutual capacitance coupled to the first sensor electrodes TE11 to TE1n is sensed by using the first sensing lines at both upper and lower ends, thereby identifying a user attempting to make a touch or hover input in the upper and lower directions.

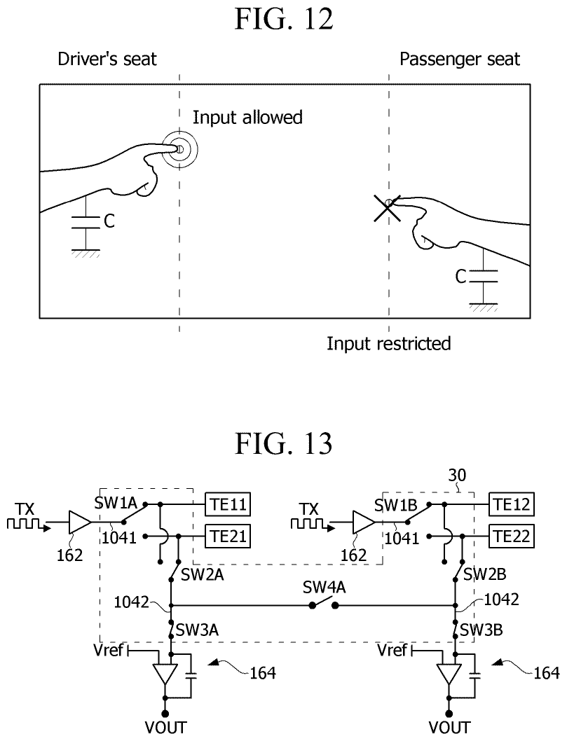

If a user attempting to make a touch or hover input is identified during the user identification interval, the host system 200 may launch an associated application program, or establish or change the control right for the touch and hover input. For example, as shown in FIG. 12, the host system 200 may allow touch and hover inputs on the in-vehicle display device only to a driver and restrict the touch and hover inputs to a passenger in the passenger seat. In another embodiment, the host system 200 may allow a driver and a passenger different screen touch and hover input control rights on the in-vehicle display device for driving safety while the vehicle is driving. For example, a driver might be allowed a touch input on a navigation screen or an instrument panel screen, while being restricted from a touch input on a passenger-side screen controlled at a narrow viewing angle.

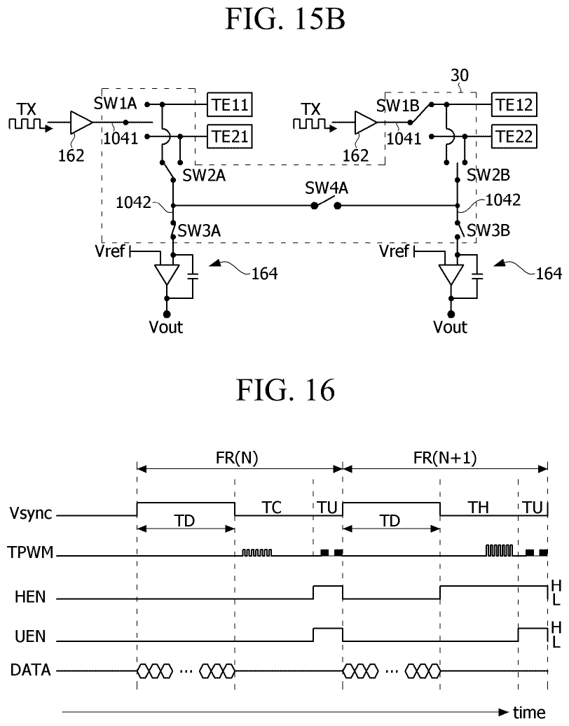

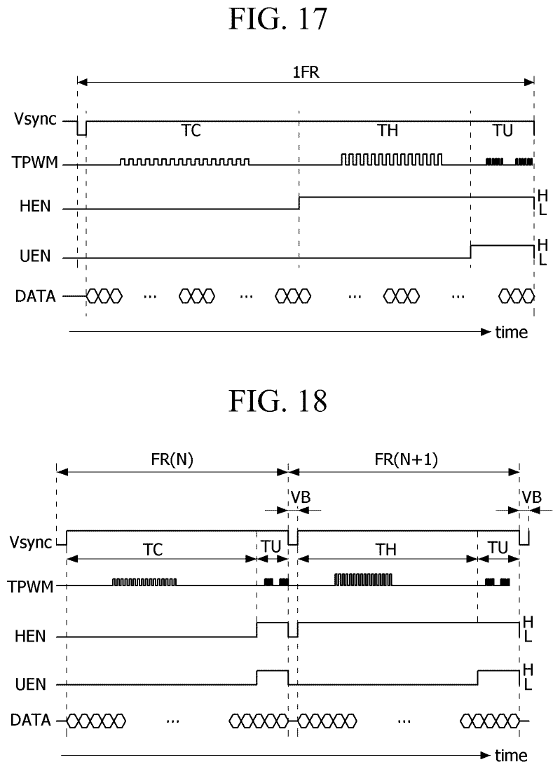

FIG. 13 is a circuit diagram illustrating an example of a connection relationship between the sensor electrodes and the drivers in the mutual capacitance sensing method as shown in FIG. 9. FIG. 14 is a circuit diagram illustrating an example of a connection relationship between the sensor electrodes and the drivers in the self-capacitance sensing method as shown in FIG. 10. FIGS. 15A and 15B are circuit diagrams illustrating an example of a connection relationship between the sensor electrodes and the drivers in the self-capacitance sensing method as shown in FIG. 11.

Referring now to FIG. 13 to 15B, the switch circuit 30 includes first switch elements SW1A and SW1B connecting the first driver 162 to one of the first sensor electrodes TE11 to TE1nand the second sensor electrodes TE21 to TE2m, second and third switch elements SW2A, SW2B, SW3A, SW3B connecting the second driver 164 to one of the first sensor electrodes TE11 to TE1nand the second sensor electrodes TE21 to TE2m, and a fourth switch element SW4A binding the adjacent sensing lines. The switch elements SW1A to SW4A may be turned on/off under the control of the sensor controller 170.

Referring to FIGS. 3, 9, and 13, the first switch elements SW1A and SW1B connect the first sensor electrodes TE11 and TE12 to the first driver 162 to deliver the pulse of the driving signal TX to the first sensor electrodes TE11 and TE12. The second and third switch elements SW2A, SW2B, SW3A, and SW3B connect the second sensor electrodes TE21 and TE22 to the second driver 164. The fourth switch element SW4A is turned off to electrically separate adjacent second sensing lines 1042. In this configuration, a charge or voltage of mutual capacitance Cm may be sensed through each of the second sensing lines 1042.

Referring to FIGS. 3, 10, and 14, the first switch elements SW1A and SW1B connect the first sensor electrodes TE11 and TE12 to the first driver 162 to deliver the pulse of the driving signal TX to the first sensor electrodes TE11 and TE12n. To bind RX channels, the second switch elements SW2A and SW2B connect the second sensor electrodes TE21 and TE21 to their corresponding third switch elements SW3A and SW3B, and the fourth switch element SW4A is turned on to connect the adjacent second sensing lines 1042. In this configuration, the second sensing lines 1042 are bound by i, allowing a charge or voltage of mutual capacitance Cm to be sensed by the second driver 164 of the selected RX channel.

Referring to FIG. 15A, the left sensing circuit may be a sensing circuit in a first longitudinal channel connected to the leftmost second-first sensor electrode TE21 in the upper part of FIG. 11, and the right sensing circuit may be a sensing circuit in a second longitudinal channel connected to the second-second sensor electrode TE22 adjacent to the leftmost second-first sensor electrode TE21.

A first-first switch element SW1A is turned off and is in a floating state. Second-first switch elements SW2A and third-first switch elements SW3A connect the second-first sensor electrode TE21 to the second driver 164, causing the first longitudinal channel to act as an RX sensing channel that senses the charge or voltage of the mutual capacitance. A first-second switch element SW1B connects the first driver 162 to the second-second sensor electrode TE22, causing the second longitudinal channel to act as a TX driving channel. In this case, second-second switch elements SW2B and third-second switch element SW3B and a fourth switch element SW4A are in the off state.

Referring to FIG. 15B, the left sensing circuit may be a sensor circuit in a first transverse channel connected to the uppermost first-first sensor electrode TE11 in the lower part of FIG. 11, and the right sensing circuit may be a sensor circuit in a second transverse channel connected to the upper first-second sensor electrode TE12 adjacent the uppermost first-first sensor electrode TE11.

The first-first switch element SW1A is turned off and is in a floating state. The second-first and third-first switch elements SW2A and SW3A connect the first-first sensor electrode TE11 to the second driver 164, causing the first transverse channel to act as an RX sensing channel that senses the charge or voltage of the mutual capacitance. The first-second switch element SW1B connects the first driver 162 to the first-second sensor electrode TE12, causing the second transverse channel to act as a TX driving channel. In this case, the second-second and third-second switch elements SW2B and SW3B and the fourth switch element SW4A are in the off state.

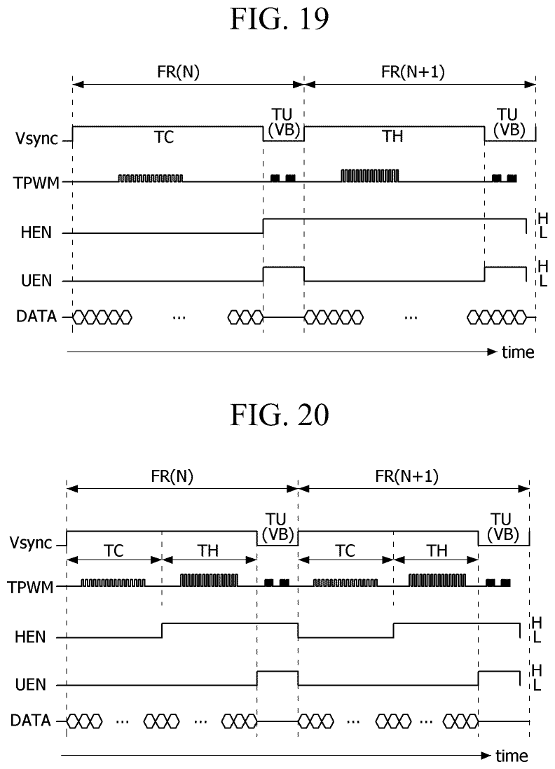

FIGS. 16 to 20 are waveform diagrams illustrating a touch display device and a driving method thereof according to another embodiment of the present disclosure. In these embodiments, description duplicating the foregoing description of the embodiment of FIG. 8 is omitted.

Referring to FIG. 16, an (N)th (N is a positive integer) frame period FR(N) may be time-divided into the display interval TD, the touch sensing interval TC, and the user identification interval TU. An (N+1)th frame period FR(N+1) may be time-divided into the display interval TD, the hover sensing interval TH, and the user identification interval TU. In this embodiment, since the touch sensing interval TC and the hover sensing interval TH are separated for each frame to further secure each sensing time, the sensing sensitivity of the touch input and the hover input may be improved.

During the display interval TD, pixel data of the input image is written to the pixels to drive the pixels. At this point, the image is displayed in the pixels. The touch and hover sensors TS are not driven during the display interval TD.

The touch and hover sensors TS are driven during the touch sensing interval TC, the hover sensing interval TH, and the user identification interval TU. During the touch sensing interval TC, the hover sensing interval TH, and the user identification interval TU, no new pixel data is written to the pixels, but the pixels may maintain the luminance of the light-emitting elements with the data voltage previously charged to a storage capacitor.

The pulse of the reference driving signal TPWM may be input to the sensor driver 160 during the touch sensing interval TC, the hover sensing interval TH, and the user identification interval TU to cause the pulse of the driving signal TX to be applied to the touch and hover sensors TS. One or more of the pulse voltage and frequency of the driving signal TX may be set differently for each interval.

The hover enable signal HEN may be at an inactive level (L) during the display interval TD and the touch sensing interval TC, and at the active level (H) during the hover sensing interval TH and the user identification interval TU. The user identification enable signal UEN may be at an inactive level (L) during the display interval TD, the touch sensing interval TC, and the hover sensing interval TH, and may be at an active level (H) during the user identification interval TU.

During the touch sensing interval TC, a touch input made on the touch screen may be sensed. During the hover sensing interval TH, a hover input in a non-contact state may be sensed over the touch screen. During the user identification interval TU, a user approaching over the touch screen in a non-contact state may be sensed by the hover sensing method.

FIGS. 17 to 20 illustrate embodiments in which the display driving and the touch and hover sensing are processed in parallel, and the touch and hover sensors are driven while the pixels are driven.

Referring to FIG. 17, a one frame period (1FR) may be time-divided into a display and touch sensing interval TC, a display and hover sensing interval TH, and a display and user identification interval TU. In this embodiment, since the display driving and the touch sensing are performed simultaneously, and the display driving and the hover sensing are performed simultaneously, it may be possible to sufficiently secure the data voltage charging time of the pixels and the touch sensing and the hover sensing time. In addition, display driving and user identification may be performed simultaneously. Therefore, this embodiment may improve the charge rate of the pixels and the sensitivity of the touch and hover sensing.

Referring to FIG. 18, an (N)th frame period FR(N) may be time-divided into a display and touch sensing interval TC and a display and user identification interval TU. An (N+1)th frame period FR(N+1) may be time-divided into the display and hover sensing interval TH and the display and user identification interval TU. In FIG. 18, “VB” is a vertical blank period in which the pixels are not driven because there is no pixel data and the touch and hover sensors TS are not driven. In this embodiment, since the display driving and the touch sensing are performed simultaneously, and the display driving and the hover sensing are performed simultaneously, it may be possible to sufficiently secure the data voltage charging time of the pixels and the touch sensing and the hover sensing time. In addition, display driving and user identification may be performed simultaneously. Therefore, this embodiment may improve the charge rate of the pixels and the sensitivity of the touch and hover sensing.

In FIGS. 17 and 18, during the display and touch sensing interval TC, the pixel data DATA of the input image is written to the pixels to drive the pixels, and the touch and hover sensors TS are driven to sense a touch input made on the touch screen. During the display and hover sensing interval TH, the pixel data of the input image is written to the pixels to drive the pixels, and at the same time, a hover input in a non-contact state may be sensed over the touch screen. During the display interval TD and user identification interval TU, the pixel data of the input image is written to the pixels to drive the pixels, and a user approaching over the touch screen in a non-contact state may be sensed by the hover sensing method.

Referring to FIG. 19, an (N)th frame period FR(N) may be time-divided into a display and touch sensing interval TC and a user identification interval TU. An (N+1)th frame period FR(N+1) may be time-divided into the display and hover sensing interval TH, and the user identification interval TU. In this embodiment, since the display driving and the touch sensing are performed simultaneously, and the display driving and the hover sensing are performed simultaneously, it may be possible to sufficiently secure the data voltage charging time of the pixels and the touch sensing and the hover sensing time. Therefore, this embodiment may improve the charge rate of the pixels and the sensitivity of the touch and hover sensing.

Referring to FIG. 20, an (N)th frame period FR(N) may be time-divided into the display and touch sensing interval TC, and the user identification interval TU. An (N+1)th frame period FR(N+1) may be time-divided into the display and hover sensing interval TH, and the user identification interval TU. In this embodiment, a user may be identified by the hover sensing method during an extended vertical blank period VB because the display driving and the touch sensing are performed simultaneously during an active period in which the pixels are driven every frame period, and the display driving and the hover sensing are performed simultaneously. Therefore, it is possible to ensure a sufficient data voltage charging time of the pixels and to perform the touch sensing and the hover sensing every frame period to improve the touch and hover report rate, thereby improving the sensing sensitivity of each of the touch input and the hover input.

In the embodiments illustrated in FIGS. 19 and 20, the user identification interval TU is set within the extended vertical blank period VB in each frame period FR(N) and FR(N+1). Since there is no pixel data within the extended vertical blank period VB, the pixels are not driven, and a user attempting to make the touch and hover inputs may be identified by the hover sensing method during the vertical blank period VB.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The aspects to be achieved by the present disclosure, the means for achieving the aspects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A touch display device, comprising:
pixels configured to display an input image;
a pixel driving circuit configured to write pixel data of the input image to the pixels;
touch and hover sensors configured to sense a touch input and a hover input; and
a sensor driving circuit configured to drive the touch and hover sensors,
wherein the sensor driving circuit is configured to bind sensing lines connected to the touch and hover sensors to sense the hover input and identify a user.

2. The touch display device of claim 1, wherein:
the touch and hover sensors include:
a plurality of first sensor electrodes connected to a plurality of first sensing lines parallel to each other; and
a plurality of second sensor electrodes connected to a plurality of second sensing lines, the plurality of second sensing lines intersecting the plurality of first sensing lines, and the plurality of second sensing lines being parallel to each other, and
wherein the sensor driving circuit includes:
a sensor driver configured to apply a driving signal to capacitance of the touch and hover sensors, and the sensor driver configured to sense an amount of a charge or voltage change in the capacitance; and
a sensor controller configured to control the sensor driver.

3. The touch display device of claim 2, wherein the sensor controller is configured to provide the sensor driver with a reference driving signal directing the sensor driver to output the driving signal, a hover enable signal directing hover sensing, and a user identification enable signal directing user identification by the hover sensing.

4. The touch display device of claim 3, wherein the sensor driver is configured to output a pulse of the driving signal in response to the reference driving signal, and the sensor driver is configured to vary at least one of a voltage and a frequency of the driving signal.

5. The touch display device of claim 2, wherein the sensor driver includes:
a first driver configured to apply the driving signal to the sensing lines;
a second driver including an amplifier, wherein a predetermined reference voltage or the driving signal is applied to a non-inverting terminal of the amplifier; and
a switching circuit configured to connect the first driver and an inverting terminal of the amplifier to a corresponding first sensing line or a corresponding second sensing line.

6. The touch display device of claim 3, wherein:
the pixels are driven during a display interval;
the touch and hover sensors are driven during a touch sensing interval, a hover sensing interval, and a user identification interval;
the sensing lines are bound by a predetermined number during the hover sensing interval; and
a greater number of the sensing lines are bound during the user identification interval than during the hover sensing interval.

7. The touch display device of claim 6, wherein a voltage charged in the capacitance of the touch and hover sensors is sensed by a hover sensing during the hover sensing interval and the user identification interval.

8. The touch display device of claim 6, wherein a resolution of the hover input sensed during the hover sensing interval is lower than a resolution of the touch input sensed during the touch sensing interval.

9. The touch display device of claim 8, wherein a resolution of the hover input sensed during the user identification interval is lower than the resolution of the hover input sensed during the hover sensing interval.

10. The touch display device of claim 6, wherein one frame period of the touch display device includes the display interval, the touch sensing interval, the hover sensing interval, and the user identification interval.

11. The touch display device of claim 6, wherein an Nth frame period of the touch display device includes the display interval, the touch sensing interval, and the user identification interval, where N is a positive integer; and
wherein an N+1th frame period includes the display interval, the hover sensing interval, and the user identification interval.

12. The touch display device of claim 6, wherein the touch and hover sensors are driven at a same time as the pixels.

13. The touch display device of claim 6, wherein an Nth frame period of the touch display device includes the touch sensing interval and the user identification interval, the pixels and the touch and hover sensors are driven simultaneously in the touch sensing interval, and the pixels and the touch and hover sensors are driven simultaneously in the user identification interval, where N is a positive integer; and
wherein an N+1th frame period includes the user identification interval, the pixels and the touch and hover sensors are driven simultaneously in the hover sensing interval, and the pixels and the touch and hover sensors are driven simultaneously in the user identification interval.

14. The touch display device of claim 13, wherein between the Nth frame period and the N+1th frame period, a vertical blank period is set, and the pixels and the touch and hover sensors are not driven in the vertical blank period.

15. The touch display device of claim 13, wherein the user identification interval is set in a vertical blank period during each of the Nth frame period and the N+1th frame period, and no pixels are driven in the vertical blank period.

16. The touch display device of claim 6, wherein one frame period of the touch display device includes the touch sensing interval, the hover sensing interval and the user identification interval, the pixels and the touch and hover sensors are simultaneously driven in the touch sensing interval, the pixels and the touch and hover sensors are simultaneously driven in the hover sensing interval, and the pixels and the touch and hover sensors are simultaneously driven in the user identification interval.

17. The touch display device of claim 13, wherein the user identification interval is set in a vertical blank period, and no pixels are driven in the vertical blank period.

18. A method of driving a touch display device, comprising:
driving pixels to display an input image;
driving touch and hover sensors to sense a touch input in a contact state on a touch screen;
driving the touch and hover sensors to sense a hover input in a non-contact state over the touch screen; and
driving the touch and hover sensors to identify a user attempting to make touch and hover over the touch screen in a non-contact state.

19. The method of claim 18, wherein a voltage charged in a capacitance of the touch and hover sensors is sensed by hover sensing during a hover sensing interval and a user identification interval.

20. The method of claim 19, wherein a resolution of a hover input sensed during the hover sensing interval is lower than a resolution of a touch input sensed during a touch sensing interval; and
a resolution of a hover input sensed during the user identification interval is lower than the resolution of the hover input sensed during the hover sensing interval.
